(19) United States
(12) Patent Application Publication
(10) Pub. No.: US 2014/0176817 A1
(43) Pub. Date: Jun. 26, 2014

(54) PLASMA DISPLAY PANEL AND DRIVING METHOD THEREOF

(71) Applicant: SAMSUNG ELECTRONICS CO., LTD., Suwon-si (KR)

(72) Inventor: Jin-yong PARK, Suwon-si (KR)

(73) Assignee: SAMSUNG ELECTRONICS CO., LTD., Suwon-si (KR)

(21) Appl. No.: 14/074,217

(22) Filed: Nov. 7, 2013

(30) Foreign Application Priority Data
Dec. 20, 2012 (KR) 10-2012-0149433

(51) Int. Cl. G09G 3/296; G09G 3/291

(52) U.S. Cl. CPC G09G 3/296; G09G 3/291
USPC 348/797

(57) ABSTRACT

A display device having a plasma display panel may include a plasma display panel which includes a plurality of electrodes and a driver which supplies a driving signal to the plurality of electrodes. The driving signal having a driving waveform may include a resetting section and an addressing section and include a plurality of pulses applied between the resetting section and the addressing section.

### CROSS-REFERENCE TO RELATED APPLICATIONS

This application claims priority from Korean Patent Application No. 10-2012-0149433, filed on Dec. 20, 2012 in the Korean Intellectual Property Office, the disclosure of which is incorporated herein by reference.

### BACKGROUND

1. Field

Apparatuses and methods regarding the exemplary embodiments disclosed herein relate to a plasma display panel (PDP) and a driving method thereof, and more particularly to a plasma display panel (PDP) and a driving method thereof, in which noise is reduced.

2. Description of the Related Art

A television (TV) employing a PDP mechanically includes a combination of a panel and a driver. In the panel, glass for an upper plate including x, y electrodes and glass for a lower plate including address electrodes and discharging cells are coupled by a pressure difference. The driver broadly includes an X electrode unit, a Y electrode unit and an address unit and may be driven by waveforms for resetting, addressing and sustaining.

In driving the PDP, 300V or higher voltage may be applied for a resetting section, 60V or higher voltage may be applied for an addressing section, and 200V or higher voltage may be applied for a sustaining section. For the resetting and sustaining sections, pulses having 200V or higher voltage may be applied to the X and Y electrode units printed on the upper plate and the addressing unit of the lower plate has a voltage level of ground, thereby generating an electrostatic field and thus generating an electromagnetic field based on the pulses. Such an electromagnetic field vibrates the upper and lower plates coupled by the atmospheric pressure difference and therefore generates noise. Also, high voltage needed for panel discharge in the driver vibrates elements constituting the driver and therefore also generates noise.

Also, for the sake of improving a resetting function, a misfiring erasing function (MEF) pulse may be applied during a misfiring erasing section and may have a width of about 200 μs in the form of a rectangular or ramp waveform, and may have a frequency of 4˜5 kHz within an audible range. An electric current having such a frequency flows on the entire surface of the panel and thus generates noise, thereby causing consumer complaints in watching a PDP TV.

### SUMMARY

Additional aspects and/or advantages will be set forth in part in the description which follows and, in part, will be apparent from the description, or may be learned by practice of the invention.

One or more exemplary embodiments may provide an apparatus and method for driving a plasma display panel, in which noise caused by an audible misfiring erasing pulse applied to a misfiring erasing section is reduced.

According to an aspect of an exemplary embodiment, there is provided a display device having a plasma display panel, the device including a plasma display panel which includes a plurality of electrodes, and a driver which supplies a driving signal to the plurality of electrodes. The driving signal may have a driving waveform which includes a resetting section and an addressing section and includes a plurality of pulses applied between the resetting section and the addressing section.

In the display device, one or more of the plurality of pulses each may have a frequency equal to or higher than a predetermined value.

In the display device, the predetermined value may be equal to or higher than 20 kHz. The plurality of pulses may be regularly divided over a width of about 200 μs.

In the display device, the plurality of electrodes may include a plurality of scanning electrodes, the driver may include a scanning driver for supplying a driving signal to the scanning electrodes, and the plurality of pulses may be applied to the plurality of scanning electrodes by the scanning driver.

In the display device, the plurality of pulses may include at least one of a square waveform and a ramp waveform.

According to an aspect of an exemplary embodiment, there is provided method of driving a display device including plasma display panel having a plurality of electrodes, the plurality of electrodes include a scan electrode, a sustain electrode and an address electrode, the method including applying a driving waveform including a resetting section and an addressing section to the scan electrodes, wherein the driving waveform has a plurality of the misfiring erasing pulses between the resetting section and the addressing section.

In the method, one or more of the plurality of misfiring erasing pulses each may have a frequency equal to or higher than a predetermined value.

In the method, the predetermined value may be equal to or higher than 20 kHz. The plurality of pulses may be regularly divided over a width of about 200 μs.

In the method, the display device may include a driver having a scanning driver for supplying a driving signal to the plurality of scanning electrodes, and the plurality of misfiring erasing pulses may be applied to the plurality of scanning electrodes by the scanning driver.

In the method, the plurality of misfiring erasing pulses may include at least one of a square waveform and a ramp waveform.

According to an aspect of an exemplary embodiment, there is provided a plasma display panel, comprising at least one scanning electrode and a scanning driver to supply a driving voltage to the at least one scanning electrode. The driving voltage may include a driving waveform applied between a resetting section and an addressing section, the driving waveform including a plurality of pulses having a frequency equal to or beyond the maximum human hearing range.

At least one of the pulses among the plurality of pulses may have a frequency higher than 20 kHz. The plurality of pulses may be regularly divided over a width of about 200 μs.

The plasma display panel may further include at least one sustaining electrode disposed in a direction parallel to the at least one scanning electrode, a sustaining driver to supply a driving voltage to the at least one sustaining electrode, at least one addressing electrode disposed in a direction perpendicular to the at least one scanning electrode and the at least one sustaining electrode, and an addressing driver to supply a driving voltage to the at least one addressing electrode. The at least one addressing electrode may intersect with at least one sustaining electrode and at least one scanning electrode to form a discharging cell. The driving waveform including the plurality of pulses having the frequency equal to or beyond the maximum human hearing range may be applied to the at least one scanning electrode during a misfiring erasing section while a driving voltage is applied to at least one sustaining electrode. The plurality of pulses may include at least one of a square waveform and a ramp waveform.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a partial perspective view of a plasma display panel;

FIG. 2 is a view showing an electrode layout of the plasma display panel and a driver for each electrode;

FIG. 3 is a view showing a frame including a plurality of subfields;

FIGS. 4 and 5 illustrate driving waveforms of the conventional plasma display panel;

FIG. 6 is a view showing a conventional misfiring erasing pulse;

FIG. 7 is a view showing a driving waveform applied during a misfiring erasing section according to an exemplary embodiment; and

FIGS. 8 to 10 show noise measuring results of an apparatus for driving the plasma display panel according to an exemplary embodiment.

### DETAILED DESCRIPTION

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

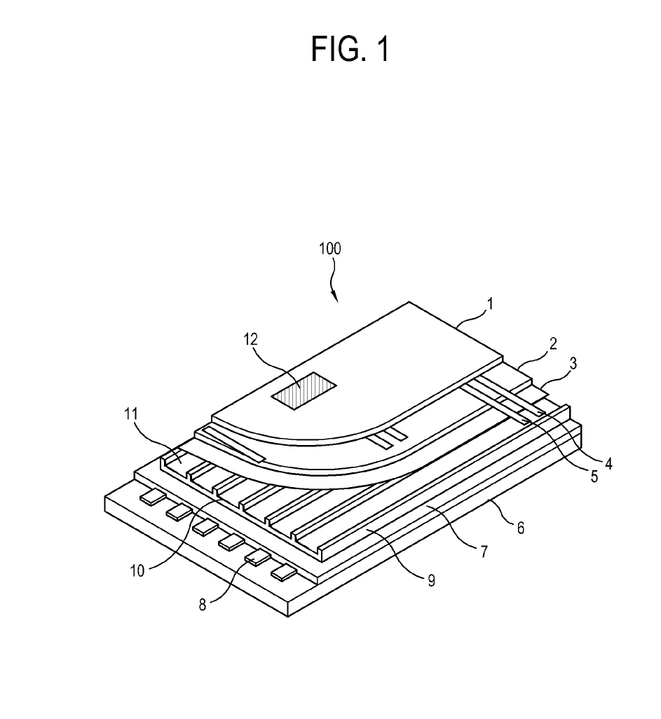

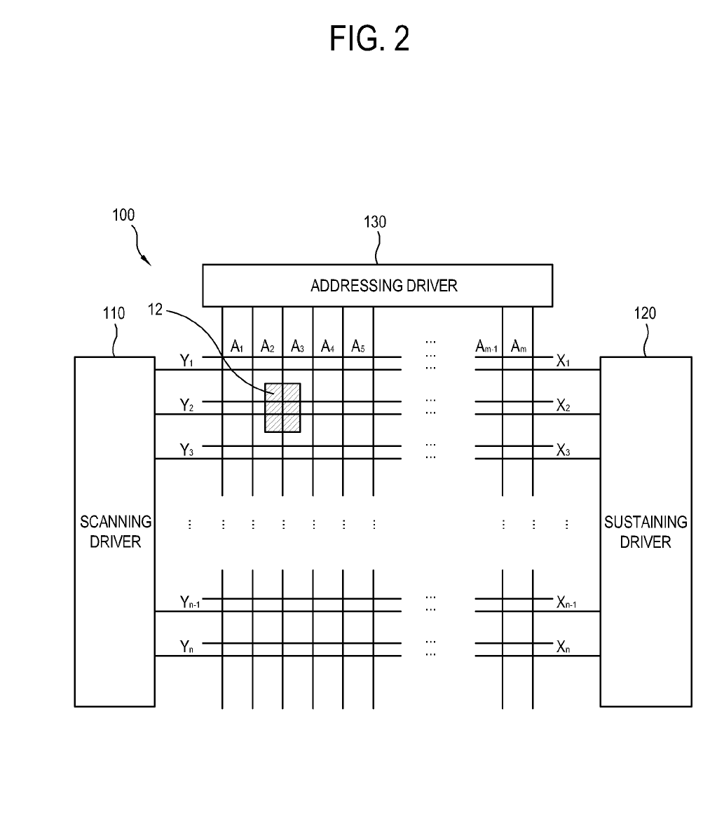

FIG. 1 is a partial perspective view of a plasma display panel, and FIG. 2 is a view showing an electrode layout of the plasma display panel and a driver for each electrode.

As shown in FIG. 1 a plasma display panel 100 may include two substrates 1 and 6 (e.g., glass substrates) opposite to and spaced from each other. On the glass substrate 1, a Y electrode 4 for scanning and an X electrode 5 for sustaining form a pair and are parallel with each other. The scanning electrode 4 and the sustaining electrode 5 may be covered with a dielectric layer 2 and a protective layer 3. There may be a plurality of scanning electrodes 4 and sustaining electrodes 5, which are arranged in an alternating pattern. On the glass substrate 6, a plurality of addressing electrodes 8 may be formed. The addressing electrode 8 may be covered with an insulating layer 7. A partition wall 9 may be formed on the insulating layer 7. Also, a fluorescent material 10 may be formed on the surface of the insulating layer 7 and between partition walls 9 (e.g., between two adjacent partition walls 9). The glass substrates 1 and 6 may be arranged to face each other with a discharging space 11 therebetween so that the scanning electrode 4 is perpendicular to the addressing electrode 8 and the sustaining electrode 5 is perpendicular to the addressing electrode 8. As can be seen from FIG. 1, the insulating layer 7, dielectric layer 2, and protective layer 3 may be between the addressing electrode 8 and the scanning electrode 4 and sustaining electrode 5. The discharging space 11, in which the addressing electrode 8 intersects the scanning and sustaining electrodes 4 and 5 forming a pair, may form a discharging cell 12. That is, as shown in FIG. 2, an area (e.g., a rectangular area) in which an addressing electrode (e.g., A3) intersects a scanning electrode (e.g., Y2) and a sustaining electrode (e.g., X2), may be referred to as a discharging space.

Referring to FIG. 2, the electrodes of the plasma display panel 100 may have a matrix structure of n×m. In a vertical direction, m addressing electrodes (e.g., A1−Am) may be arranged. In a horizontal direction, n pairs of scanning and sustaining electrodes (e.g., Y1−Yn and X1−Xn) may be arranged.

Also, the plasma display panel 100 according to an exemplary embodiment may include a scanning driver 110 for applying a driving voltage to the respective scanning electrodes Y1−Yn, a sustaining driver 120 for applying a driving voltage to the respective sustaining electrodes X1−Xn, and an addressing driver 130 for applying a driving voltage to the respective addressing electrodes A1−Am.

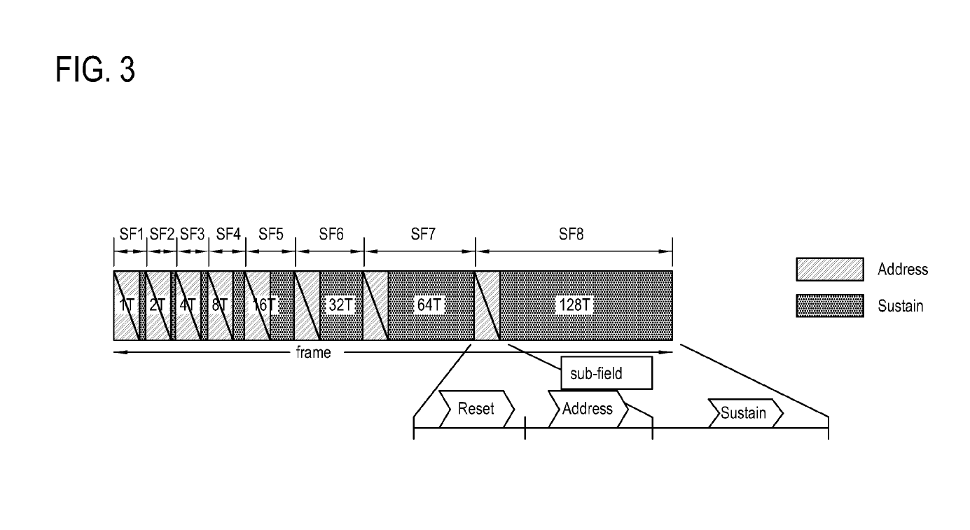

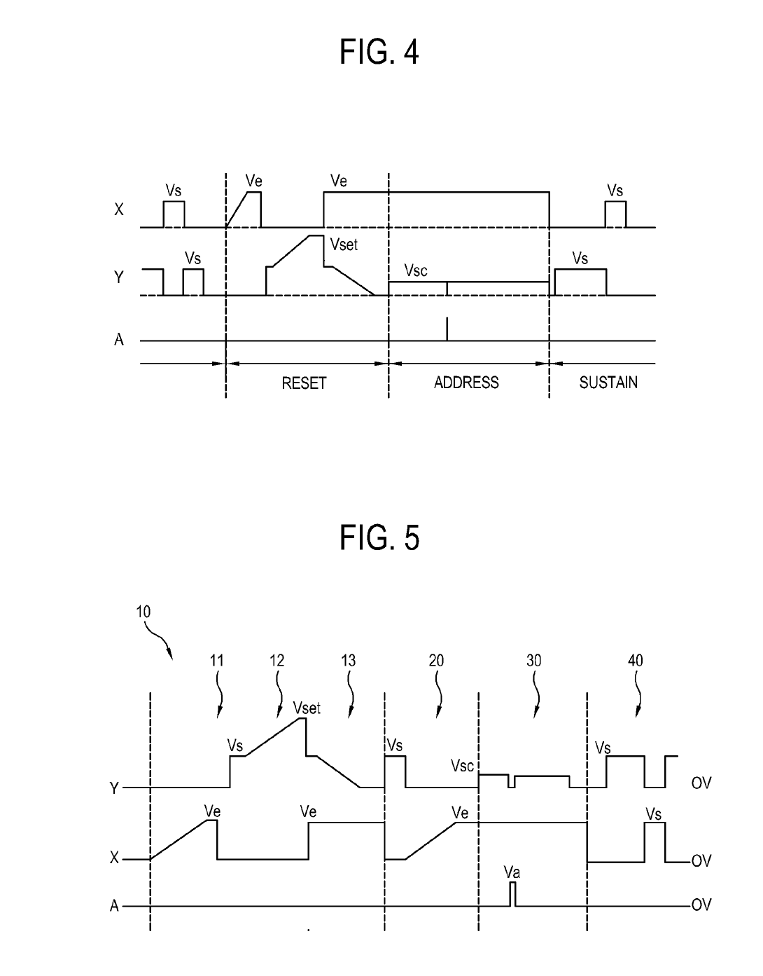

FIG. 3 is a view showing a frame including a plurality of subfields, and FIGS. 4 and 5 illustrate driving waveforms of the conventional plasma display panel.

As shown in FIG. 3, the plasma display panel may generally be driven in such a manner that one frame is divided into a plurality of subfields and a gradation may be represented by combination of subfields. Referring to FIG. 3, one frame may be divided into a plurality of subfields (e.g., eight subfields). Also, each subfield may have a different period of time associated with it or may be equal. For example, a duration of time associated with each subfield may increase sequentially (i.e., a length of time associated with the second subfield may be greater than the length of time associated with the first subfield, a length of time associated with the third subfield may be greater than the length of time associated with the second subfield, and so on).

As shown in FIG. 4, each subfield may include a resetting section, an addressing section and a sustaining section. Referring back to FIG. 3, each subfield may be divided into sections corresponding to the resetting section, addressing section and sustaining section. Also, each respective section may have a different period of time associated with it in a subfield, or they may be equal to one another (e.g., in a first subfield a period for the reset section may be equal to or different from a period for the sustain section). Further, each respective section may have a different period of time associated with it in one subfield than in another subfield, or they may be equal to one another (e.g., a period for the reset section in a first subfield may be equal to or different from a period for the reset section in a second subfield). For example, a duration of time associated with the sustaining section may increase sequentially (i.e., a length of time associated with the sustaining section in the second subfield may be greater than the length of time associated with the sustaining section in the first subfield, a length of time associated with the sustaining section in the third subfield may be greater than the length of time associated with the sustaining section in the second subfield, and so on).

During the resetting section, wall electric charges may be set up for erasing the wall electric charges formed by previous sustaining and discharging and for stably performing the next addressing discharging. During the addressing section, cells to be turned on and cells not to be turned on are selected so that the wall electric charges are accumulated on the turned on cells (i.e., the addressed cell). During the sustaining section, the sustaining and discharging are performed for actually displaying an image on the addressed cell.

Here, if a normal operation is performed during the resetting section, the wall electric charges are removed from the scanning electrode Y and the sustaining electrode X. However, an unstable resetting operation may cause an unstable electric discharge. The unstable electric discharge may be caused, for example, when electric discharge occurs due to self-erasing at a setup voltage Vset voltage drop of the scanning electrode Y after a strong electric discharge occurs during a ramp ascending section, and when strong electric discharge occurs during a ramp descending section.

In the first case, the resetting function may be performed by self-erasing. However, in the second case, (+) wall electric charges are formed on the scanning electrode Y and (−) wall electric charges are formed on the sustaining electrode X due to the strong electric discharge of the ramp descending section. At this time, a wall voltage based on the wall electric charges formed on the scanning electrode Y and the sustaining electrode X may cause sustaining discharge during the sustaining section without addressing discharge during the addressing section.

In such a conventional driving method, the sustaining discharge may be caused in even the discharge cell that does not have to be turned on due to the strong electric discharge during the ramp descending section of the resetting section. To erase such misfiring, a misfiring erasing function pulse is applied.

FIG. 5 is a view showing waveforms for driving a plasma display panel having such a misfiring erasing section.

As shown in FIG. 5, the driving waveforms may include a resetting section 10, a misfiring erasing section 20, an addressing section 30 and a sustaining section 40.

The resetting section 10 may include an erasing section 11, a ramp ascending section 12 and a ramp descending section 13. The erasing section 11 of the resetting section 10 may erase the electric charges formed by the sustaining electric discharge during the sustaining section 40 in the previous subfield. The ramp ascending section 12 may form the wall electric charges on the scanning electrode Y, the sustaining electrode X and the addressing electrode A. The ramp descending section 13 may erase some wall electric charges formed during the ramp ascending section 12 and facilitate the addressing electric discharge. Here, Ve may refer to an erasing waveform, and Vs may refer to a sustaining voltage.

The misfiring erasing section 20 may erase the wall electric charges, which are formed due to an unstable strong electric discharge during the ramp descending section 13, from the scanning electrode Y and the sustaining electrode X. During the misfiring erasing section 20, a misfiring erase pulse waveform may be applied to the scanning electrode Y while the sustaining electrode X sustains a reference voltage. The misfiring erasing pulse waveform may be applied in the form of a square waveform or a ramp waveform.

The addressing section 30 may select an electric discharge cell, in which the sustaining electric discharge will occur, among a plurality of electric discharge cells. During the addressing section 30, scanning pulses (e.g., Vsc) may in turn be applied to the scanning electrode Y in order to select the electric discharge cell, and addressing pulses (e.g., Va) may be applied to the addressing electrode A to be selected among the addressing electrodes A intersecting the scanning electrode Y to which the scanning pulses are applied.

The sustaining section 40 may sustain the electric discharge in the electric discharge cell selected during the addressing section 30 by applying the sustaining pulses in turn to the scanning electrode Y and the sustaining electrode X. That is, during the sustaining section 40, the sustaining pulses are in turn applied to the scanning electrode Y and the sustaining electrode X (e.g., by alternating the sustaining pulses between the scanning electrode Y and the sustaining electrode X). As shown in FIG. 5, a sustaining pulse is applied to the scanning electrode Y and then applied to the sustaining electrode X, however the order of the application of the sustaining pulse to the scanning electrode Y and the sustaining electrode X may be reversed.

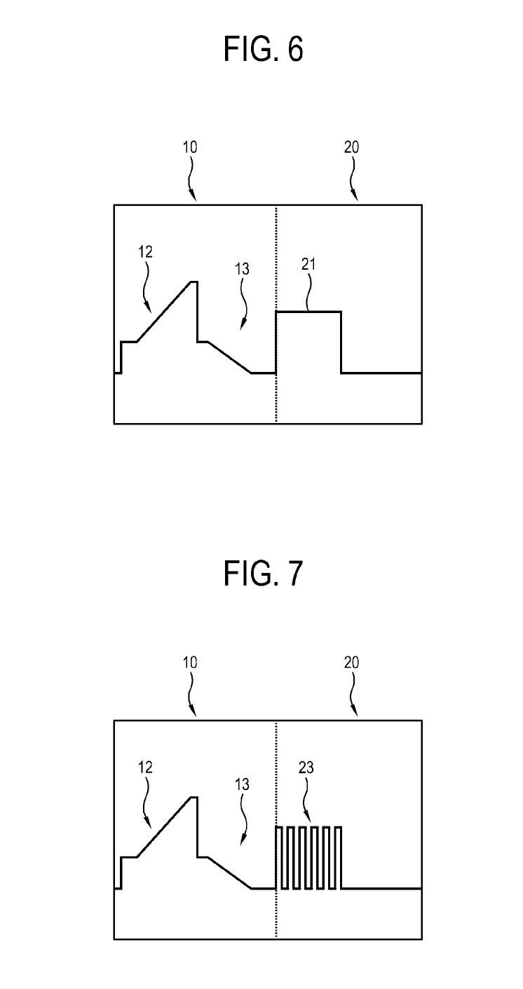

FIG. 6 is a view showing a conventional misfiring erase pulse, and FIG. 7 is a view showing a driving waveform applied during a misfiring erasing section according to an exemplary embodiment.

As shown in FIG. 6, a conventional misfiring erasing pulse 21 applied to the misfiring erasing section 20 has a width of about 200 μs and a frequency of about 4˜5 kHz which is within an audible range. The electric current having such a frequency flows on the entire surface of the panel, and thus causes noise.

Accordingly, the misfiring erasing pulse 21 of FIG. 6 is divided and applied as a plurality of pulses. For example, the misfiring erasing pulse may be applied to the misfiring erasing section 20 according to an exemplary embodiment as shown in FIG. 7. That is, the misfiring erasing pulse may be divided into a plurality of pulses 23 having a frequency equal to or higher than a predetermined value.

The plurality of pulses 23, into which the misfiring erasing pulse 21 having a width of about 200 μs is divided, may have a frequency that a human cannot hear, for example, a frequency of 20 kHz or higher. That is, the human hearing range is known to be from about 15 to 20,000 Hz. The misfiring erasing pulse 21 having a width of about 200 μs may be regularly (equally) divided, or may be irregularly divided (unevenly). However, in the example embodiment it is desired that each of the plurality of pulses have a frequency outside a hearing range of a human to reduce noise. For example, each of the plurality of pulses may have a frequency of 20 kHz or higher.

According to an exemplary embodiment, the audible misfiring erasing pulse of the driving waveform applied during the misfiring erasing section may be divided into a plurality of waveforms, thereby reducing noise caused by the conventional misfiring erasing pulse as well as performing the misfiring erasing function.

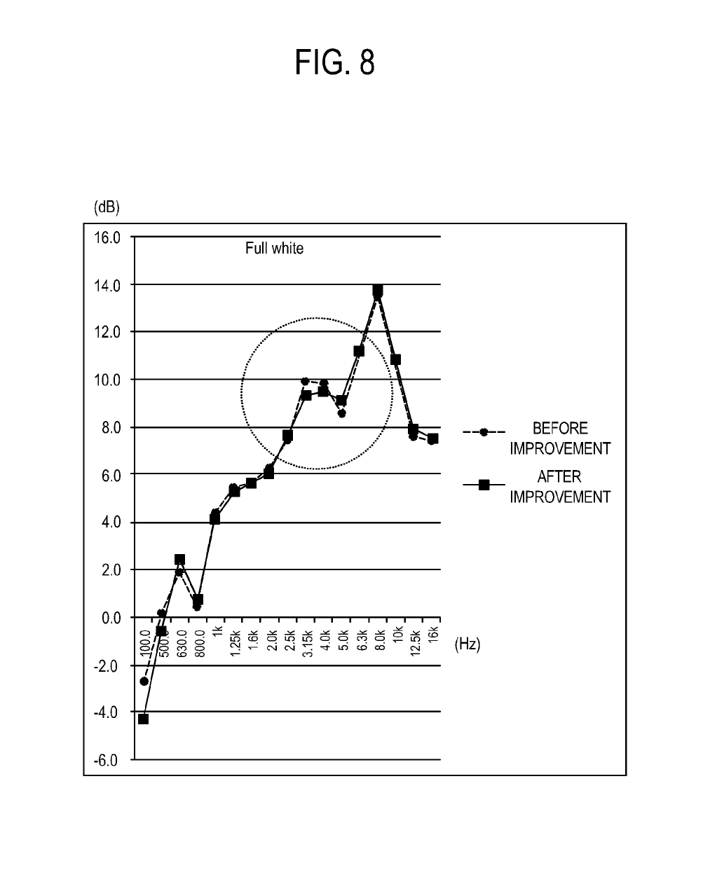

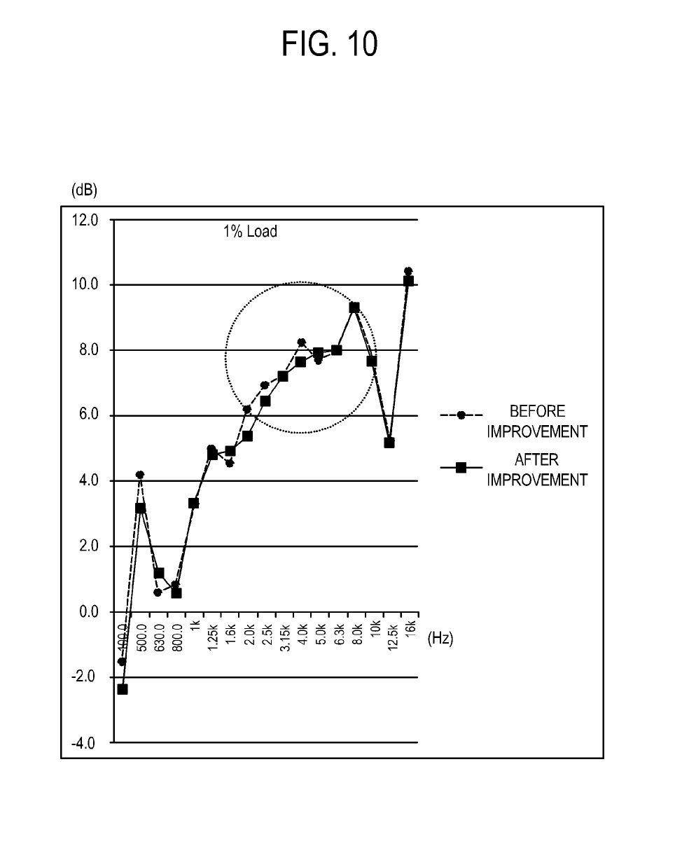

FIGS. 8 to 10 show results from measuring noise in an apparatus for driving the plasma display panel according to an exemplary embodiment.

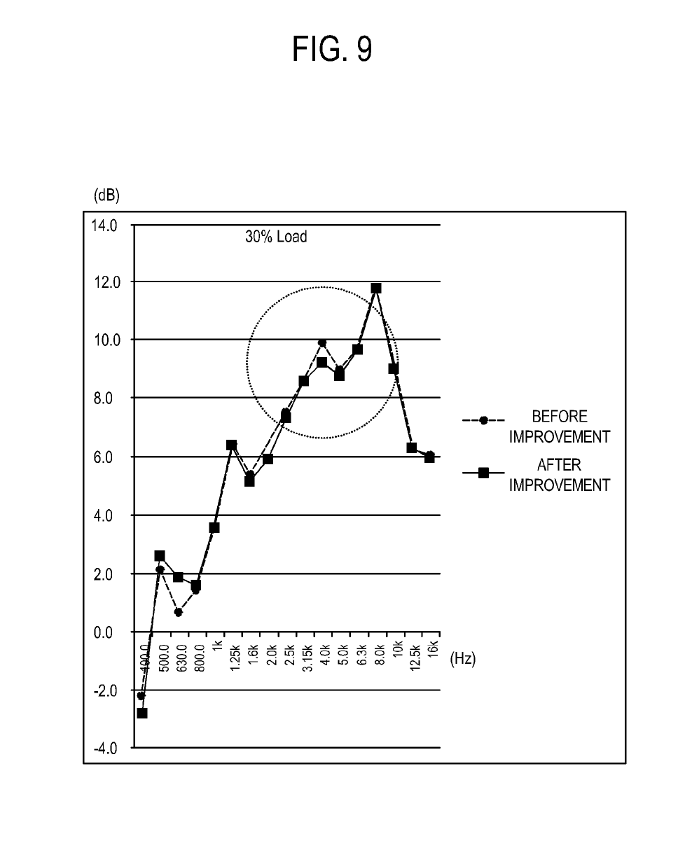

The noise was measured at a point distant by about 50 cm from the center of the plasma display panel according to an exemplary embodiment, and as shown in FIGS. 8 to 10 the measurement results show that noise caused by the misfiring erasing pulse was reduced by about 1 dB around 4 kHz. For example, FIGS. 8 through 10 show various scenarios in which noise was measured in an apparatus for driving the plasma display panel according to an exemplary embodiment and compared to a conventional apparatus lacking the misfiring erasing section of FIG. 7. For example, FIG. 8 illustrates results obtained during a full white pattern while FIGS. 9 and 100 illustrate results obtained at a 30% load and 1% load, respectively.

As described above, according to an exemplary embodiment, it is possible to reduce noise caused by the audible misfiring erasing pulse applied during the misfiring erasing section. The plasma display panel according to the above-described example embodiments may be applied to a television or to any display device (e.g. a computer, smartphone, tablet, etc.) which may be configured to, suitable for, capable of, operable to, adapted to, etc. implementing or incorporating the plasma display panel as disclosed herein.

The display device including the plasma display panel according to the above-described example embodiments may use one or more processors. Methods to implement or perform the operations of the display device including the plasma display panel according to the above-described example embodiments may use one or more processors. For example, a processing device may be implemented using one or more general-purpose or special purpose computers, such as, for example, a processor, an image processor, a controller and an arithmetic logic unit, a central processing unit (CPU), a graphics processing unit (GPU), a digital signal processor (DSP), a microcomputer, a field programmable array, a programmable logic unit, an application-specific integrated circuit (ASIC), a microprocessor or any other device capable of responding to and executing instructions in a defined manner.

Some example embodiments of the disclosure can also be embodied as a computer readable medium including computer readable code/instruction to control at least one component of the above-described example embodiments. The medium may be any medium that can storage and/or transmission the computer readable code.

Aspects of the above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The media may be transfer media such as optical lines, metal lines, or waveguides including a carrier wave for transmitting a signal designating the program command and the data construction. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa. In addition, a non-transitory computer-readable storage medium may be distributed among computer systems connected through a network and computer-readable codes or program instructions may be stored and executed in a decentralized manner. In addition, the computer-readable storage media may also be embodied in at least one application specific integrated circuit (ASIC) or Field Programmable Gate Array (FPGA). Some or all of the operations performed according to the above-described example embodiments may be performed over a wired or wireless network, or a combination thereof.

Although exemplary embodiments have been shown and described, it will be appreciated by those skilled in the art that changes may be made to these exemplary embodiments without departing from the principles and spirit of the invention, the scope of which is defined in the appended claims and their equivalents.

What is claimed is:

1. A display device comprising:
a plasma display panel which comprises a plurality of electrodes; and
a driver to supply a driving signal to the plurality of electrodes,
wherein the driving signal includes a driving waveform which comprises a resetting section and an addressing section and includes a plurality of pulses applied between the resetting section and the addressing section.

2. The device according to claim 1, wherein at least one of the plurality of pulses has a frequency equal to or higher than a predetermined value.

3. The device according to claim 2, wherein the predetermined value is equal to or higher than 20 kHz.

4. The device according to claim 3, wherein the plurality of pulses are regularly divided over a width of about 200 μs.

5. The device according to claim 1, wherein the plurality of electrodes comprises a plurality of scanning electrodes,
the driver comprises a scanning driver to supply a driving signal to the plurality of scanning electrodes, and
the plurality of pulses are applied to the plurality of scanning electrodes by the scanning driver.

6. The device according to claim 1, wherein the plurality of pulses comprises at least one of a square waveform and a ramp waveform.

7. A method of driving a display device comprising a plasma display panel including a plurality of electrodes, the plurality of electrodes comprising at least one scan electrode, the method comprising:
applying a driving waveform comprising a resetting section and an addressing section to the at least one scan electrode,
wherein the driving waveform has a plurality of misfiring erasing pulses between the resetting section and the addressing section.

8. The method according to claim 7, wherein at least one of the plurality of misfiring erasing pulses has a frequency equal to or higher than a predetermined value.

9. The method according to claim 8, wherein the predetermined value is equal to or higher than 20kHz.

10. The method according to claim 9, wherein the plurality of pulses are regularly divided over a width of about 200 μs.

11. The method according to claim 7, wherein the display device includes a scanning driver, and the method further comprises:
supplying a driving signal, using the scanning driver, to the at least one scan electrode, and
applying, by the scanning driver, the plurality of misfiring erasing pulses to the at least one scan electrode.

12. The method according to claim 7, wherein the plurality of misfiring erasing pulses comprises at least one of a square waveform and a ramp waveform.

13. A plasma display panel, comprising:
at least one scanning electrode; and
a scanning driver to supply a driving voltage to the at least one scanning electrode,
wherein the driving voltage includes a driving waveform applied between a resetting section and an addressing section, the driving waveform including a plurality of pulses having a frequency equal to or beyond the maximum human hearing range.

14. The plasma display panel according to claim 13, wherein at least one of the pulses among the plurality of pulses has a frequency higher than 20 kHz.

15. The plasma display panel according to claim 14, wherein the plurality of pulses are regularly divided over a width of about 200 μs.

16. The plasma display panel according to claim 13, further comprising:
at least one sustaining electrode disposed in a direction parallel to the at least one scanning electrode;
a sustaining driver to supply a driving voltage to the at least one sustaining electrode;
at least one addressing electrode disposed in a direction perpendicular to the at least one scanning electrode and the at least one sustaining electrode; and
an addressing driver to supply a driving voltage to the at least one addressing electrode,
wherein at least one addressing electrode intersects with at least one sustaining electrode and at least one scanning electrode to form a discharging cell.

17. The plasma display panel according to claim 16, wherein the driving waveform including the plurality of pulses having the frequency equal to or beyond the maximum human hearing range is applied to the at least one scanning electrode during a misfiring erasing section while a driving voltage is applied to at least one sustaining electrode.

18. The plasma display panel according to claim 13, wherein the plurality of pulses comprises at least one of a square waveform and a ramp waveform.
